(19) United States
(12) Patent Application Publication
(10) Pub. No.: US 2015/0315384 A1
(43) Pub. Date: Nov. 5, 2015

(54) Pneumatic Tire

(71) Applicant: THE YOKOHAMA RUBBER CO., LTD., Minato-ku, Tokyo (JP)

(72) Inventor: Hideki Seto, Hiratsuka-shi, Kanagawa (JP)

(21) Appl. No.: 14/649,496

(22) PCT Filed: Nov. 29, 2013
(86) PCT No.: PCT/JP2013/082244

§ 371 Date: Jun. 3, 2015

(30) Foreign Application Priority Data
Dec. 3, 2012 (JP) 2012-264242

(51) Int. Cl. C08L 77/06; C08L 77/02; C08L 47/00

(52) U.S. Cl. CPC C08L 77/06; C08L 47/00; C08L 77/02; C08L 2207/04

(57) ABSTRACT

A pneumatic tire has an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition. The sheet obtained from the thermoplastic resin or the thermoplastic resin composition of a thermoplastic resin blended with an elastomer has a plurality of slits extending in a direction having a tire circumferential direction component and having a slit width of not greater than 1.0 mm provided in a leading edge portion or in the vicinity of a leading edge portion of at least one side of the sheet.

### TECHNICAL FIELD

The present technology relates to a pneumatic tire.

The present technology particularly relates to a pneumatic tire having an overlap splice portion formed by laminating a sheet obtained from a thermoplastic resin or a thermoplastic resin composition of a thermoplastic resin blended with an elastomer above and below an interposed a rubber layer that undergoes vulcanizing adhesion with the thermoplastic resin or the thermoplastic resin composition, the pneumatic tire having excellent durability without generation of cracks and/or separation of the sheet obtained from the thermoplastic resin or the thermoplastic resin composition of a thermoplastic resin blended with an elastomer in the vicinity of the overlap splice portion after the pneumatic tire begins traveling.

### BACKGROUND

In recent years, the use of a sheet-like pneumatic tire inner liner obtained from a thermoplastic resin or a thermoplastic resin composition of a thermoplastic resin blended with an elastomer has been proposed and studied (see Japanese Unexamined Patent Application Publication No. 2009-241855A).

When actually using this sheet-like object obtained from the thermoplastic resin or the thermoplastic resin composition of a thermoplastic resin blended with an elastomer in a pneumatic tire inner liner, normally a manufacturing technique of winding a laminate sheet of the sheet obtained from the thermoplastic resin or the thermoplastic resin composition of a thermoplastic resin blended with an elastomer and a rubber (tie rubber) sheet that undergoes vulcanizing adhesion to the sheet obtained from the thermoplastic resin or the thermoplastic resin composition of a thermoplastic resin blended with an elastomer onto a tire molding drum, performing a lap splice, and then supplying to the tire vulcanization molding process.

However, when a tire is manufactured by winding the abovementioned laminate sheet obtained from a thermoplastic resin or a thermoplastic resin composition of a thermoplastic resin blended with an elastomer and the tie rubber layer into a roll, pulling and cutting the laminate sheet from this roll into portions of a required length, then winding the cut lengths onto a tire molding drum, performing a lap splicing and then vulcanization molding, separation may occur between the sheet obtained from the thermoplastic resin or the thermoplastic resin composition that constitutes the inner liner, and the tie rubber sheet that undergoes vulcanizing adhesion to the sheet obtained from the thermoplastic resin or the thermoplastic resin composition, after starting the travel with tire.

When explained with reference to a drawing as illustrated in FIG. 5A, a laminate sheet 1 including a sheet 2 obtained from a thermoplastic resin or a thermoplastic resin composition of a thermoplastic resin blended with an elastomer and a tie rubber layer 3, is cut into a certain size (length) with a blade or the like and then spliced on a tire molding drum so that a ring-like overlap splice portion S is formed at both edges of the laminate sheet 1. When one laminate sheet 1 is used, both edges are spliced to form a ring shape, and when a plurality of the laminate sheets 1 are used, the mutual edge portions of each of the laminate sheets 1 are spliced together to form a ring shape.

Next, other parts (not illustrated) required for tire manufacturing are wound and the tire undergoes vulcanization molding using a bladder. After the vulcanization molding, an inner liner layer 10 is formed including the tie rubber layer 3 and the sheet 2 obtained from the thermoplastic resin or the thermoplastic resin composition of a thermoplastic resin blended with an elastomer, and a portion in which the sheet 2 obtained from the thermoplastic resin or the thermoplastic resin composition is exposed and a portion in which the sheet 2 is embedded in the tie rubber layer are formed in the vicinity of an overlap splice portion S, as illustrated in FIG. 5B.

Specifically, the sheet 2 obtained from the thermoplastic resin or the thermoplastic resin composition of a thermoplastic resin blended with an elastomer is present in two layers with a tie rubber layer 3′ interposed therebetween in the vicinity of the overlap splice portion S. Note that a green tire is produced such that the sheet 2 obtained from the thermoplastic resin composition is arranged on the tire cavity side thereof, the upper side in FIGS. 5A and 5B being the tire cavity side.

The phenomenon of the sheet 2 obtained from the thermoplastic resin or the thermoplastic resin composition and the vulcanizing-adhered tie rubber sheet 3 separating after the start of use of the tire occurs in a portion in which the sheet 2 obtained from the thermoplastic resin or the thermoplastic resin composition illustrated in FIG. 5B in particular is exposed and occurs in the vicinity of a leading edge portion 4. The phenomenon first involves a crack being produced and the crack further advances, resulting in the phenomenon of the separation of the sheet.

This is caused by the following reasons: the sheet 2 obtained from the thermoplastic resin or the thermoplastic resin composition generally has a higher modulus in the low-extension region than a rubber compound; in particular, the rigidity of the splice portion becomes higher than that of other portions due to two layers being present sandwiching the tie rubber sheet, in the vicinity of the splice portion S as described above; stress is concentrated in the vicinity of the splice portion due to this difference in rigidity; and shearing strain occurring within the plane of the sheet 2 obtained from the thermoplastic resin or the thermoplastic resin composition causes generation of cracks and/or separation as well as failure or the like.

### SUMMARY

The present technology provides a pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, the pneumatic tire being excellent durability without generation of cracks and/or separation of the sheet obtained from the thermoplastic resin or a thermoplastic resin composition of a thermoplastic resin blended with an elastomer in the vicinity of the overlap splice portion after starting the travel with the pneumatic tire.

A pneumatic tire of the present technology has the configuration (1) below.

(1) A pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, the sheet obtained from the thermoplastic resin or the thermoplastic resin composition of a thermoplastic resin blended with an elastomer having a plurality of slits extending in a direction having a tire circumferential direction component and having a slit width of not greater than 1.0 mm provided in a leading edge portion or in the vicinity of a leading edge portion of at least one side of the sheet.

Furthermore, the pneumatic tire of the present technology preferably has any one of the following configurations (2) to (10).

(2) The pneumatic tire according to (1) above, wherein the slits are provided at a slit pitch of not less than 1 mm and not greater than 15 mm.

(3) The pneumatic tire according to (1) or (2) above, wherein the length of the slits, as the length of the tire circumferential direction component thereof, is not less than 0.2 times and not greater than 1.5 times the overlap length of the overlap splice portion.

(4) The pneumatic tire according to (3) above, wherein the length of the slits, as the length of the tire circumferential direction component thereof, is not less than 0.4 times and not greater than 1.0 times the overlap length of the overlap splice portion.

(5) The pneumatic tire according to any one of (1) to (4) above, wherein the slits are provided having a slit angle of from 30° to 90° relative to a direction of a leading edge portion line of the sheet obtained from the thermoplastic resin or the thermoplastic resin composition of a thermoplastic resin blended with an elastomer.

(6) The pneumatic tire according to any one of (1) to (5) above, wherein the slits are provided in the sheet obtained from the thermoplastic resin or the thermoplastic resin composition of a thermoplastic resin blended with an elastomer arranged on a tire cavity side in the overlap splice portion.

(7) The pneumatic tire according to any one of (1) to (6) above, wherein the leading edge portion of the sheet obtained from the thermoplastic resin or the thermoplastic resin composition of a thermoplastic resin blended with an elastomer in the overlap splice portion is sharpened.

(8) The pneumatic tire according to (7) above, wherein, the sharpening is performed such that a thickness T (μm) at a position located inward by a length of t×⅓ from the leading edge of the sheet obtained from the thermoplastic resin or the thermoplastic resin composition of a thermoplastic resin blended with an elastomer satisfies the equation 0.1 t≦T≦0.8 t

wherein t is the average thickness (μm) in the tire circumferential direction of a portion not subject to sharpening of the sheet obtained from the thermoplastic resin or the thermoplastic resin composition of a thermoplastic resin blended with an elastomer and

T is the thickness (μm) of the sheet 2 at a position located inward by a length of t×⅓ from the leading edge of the sheet obtained from the thermoplastic resin or the thermoplastic resin composition of a thermoplastic resin blended with an elastomer.

(9) The pneumatic tire according to any one of (1) to (8) above, wherein both side wall portions of the slits are sharpened.

(10) The pneumatic tire according to (9) above, wherein the sharpening of both side wall portions of the slits is performed such that a thickness T (μm) at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer satisfies the equation 0.1 t≦T≦0.8 t.

Here, t is the average thickness (μm) in the tire circumferential direction of a portion not subject to sharpening of the sheet obtained from the thermoplastic resin or the thermoplastic resin composition of a thermoplastic resin blended with an elastomer,

and T is the thickness (μm) of the sheet 2 at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer.

The pneumatic tire of the present technology according to claim 1 provides a pneumatic tire having an overlap splice portion formed by laminating a sheet obtained from a thermoplastic resin or the thermoplastic resin composition of a thermoplastic resin blended with an elastomer above and below an interposed rubber layer that undergoes vulcanizing adhesion with the thermoplastic resin or the thermoplastic resin composition, the pneumatic tire having excellent durability and suppressing the generation of cracks and/or separation of the sheet in the vicinity of the overlap splice portion, in which an inner liner layer or a reinforcing sheet has been overlap spliced, after the starting the travel with pneumatic tire.

In particular, according to the pneumatic tire of the present technology according to any of claims 2 to 10, it is possible to obtain the effect of the pneumatic tire of the present technology according to claim 1, and further to obtain the effect more reliably and to a greater extent.

### BRIEF DESCRIPTION OF THE DRAWINGS

FIGS. 1A to 1C are schematic views of main parts illustrating an embodiment of the pneumatic tire of the present technology, wherein FIG. 1A is a plan view in the vicinity of an overlap splice portion S, FIG. 1B is a cross-sectional view in the vicinity of the overlap splice portion S, and FIG. 1C is a cross-sectional view in the vicinity of the overlap splice portion S illustrating another embodiment of the pneumatic tire of the present technology.

FIGS. 2A and 2B are schematic views of main parts illustrating an embodiment of the pneumatic tire of the present technology, and is a plan view in the vicinity of an overlap splice portion S.

FIG. 3A to 3D are schematic views of main parts illustrating an embodiment of the pneumatic tire of the present technology, and is a plan view in the vicinity of an overlap splice portion S.

FIG. 4A to 4D are schematic views of main parts illustrating an embodiment of the pneumatic tire of the present technology, and is an explanatory view of a sharpened edge portion of a sheet 2 in the vicinity of an overlap splice portion S.

FIGS. 5A to 5B explain problems of the conventional art. FIG. 5A is a model for illustrating a state in which a laminate sheet 1 having a prescribed length and obtained by laminating a sheet 2 obtained from a thermoplastic resin or a thermoplastic resin composition and rubber 3 that undergoes vulcanizing adhesion with the thermoplastic resin or the thermoplastic resin composition, is wound onto a tire molding drum, and both edges of the laminate sheet 1 are lap spliced. FIG. 5B is a model for illustrating a state after vulcanization molding the laminate sheet 1 in the state illustrated in FIG. 5A.

FIG. 6 is a partially fragmented perspective view illustrating an example of an embodiment of the pneumatic tire according to the present technology.

### DETAILED DESCRIPTION

A detailed explanation of the pneumatic tire of the present technology will be given below.

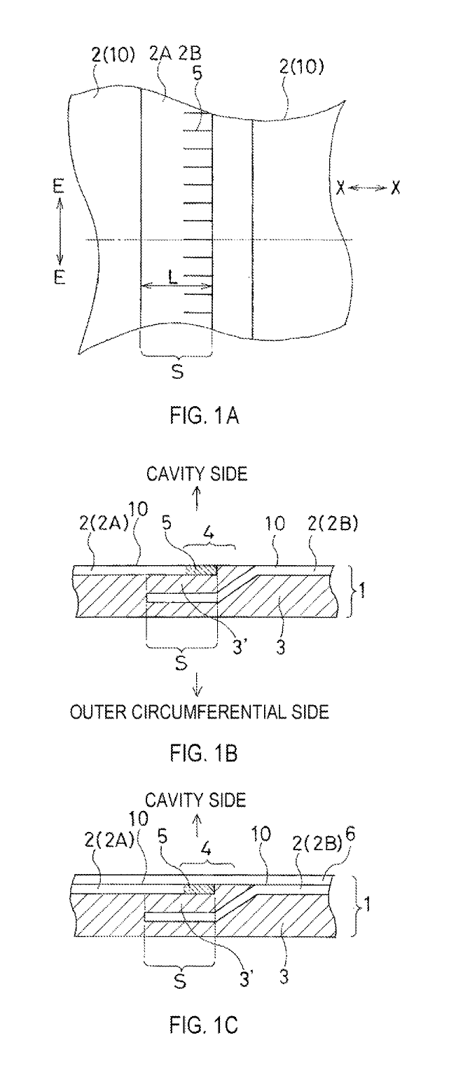

The pneumatic tire of the present technology, as illustrated in FIG. 1, is a pneumatic tire having an overlap splice portion S, formed by laminating a sheet 2 obtained from a thermoplastic resin or a thermoplastic resin composition of a thermoplastic resin blended with an elastomer above and below an interposed rubber layer 3′ that undergoes vulcanizing adhesion with the thermoplastic resin or the thermoplastic resin composition. In the pneumatic tire of the present technology, the sheet 2 obtained from the thermoplastic resin or the thermoplastic resin composition of a thermoplastic resin blended with an elastomer has a plurality of slits 5 extending in a direction having a tire circumferential direction component and having a slit width of not greater than 1.0 mm and the slits are provided in a leading edge portion or in the vicinity of a leading edge portion of at least one side of the sheet 2.

In the present technology, the sheet 2 obtained from the thermoplastic resin or the thermoplastic resin composition of a thermoplastic resin blended with an elastomer in a pneumatic tire constitutes an inner liner layer (air penetration preventing layer) or a reinforcing sheet for reinforcing certain portions of the tire.

The sheet 2 is present in the pneumatic tire employed as a laminate sheet 1 laminated with rubber such as tie rubber 3, and in the present technology, an overlap splice portion S is configured, the overlap splice portion S having a structure of edge portions of the laminate sheet being overlapped, and is disposed inside the pneumatic tire, forming the inner liner or reinforcing sheet.

In the pneumatic tire of the present technology, as illustrated in FIGS. 1A and 1B, the sheet 2 obtained from the thermoplastic resin or the thermoplastic resin composition of a thermoplastic resin blended with an elastomer that is employed has a plurality of slits 5 extending in a direction having a tire circumferential direction component and having a slit width of not greater than 1.0 mm provided in a leading edge portion or in the vicinity of a leading edge portion of at least one side of the sheet 2.

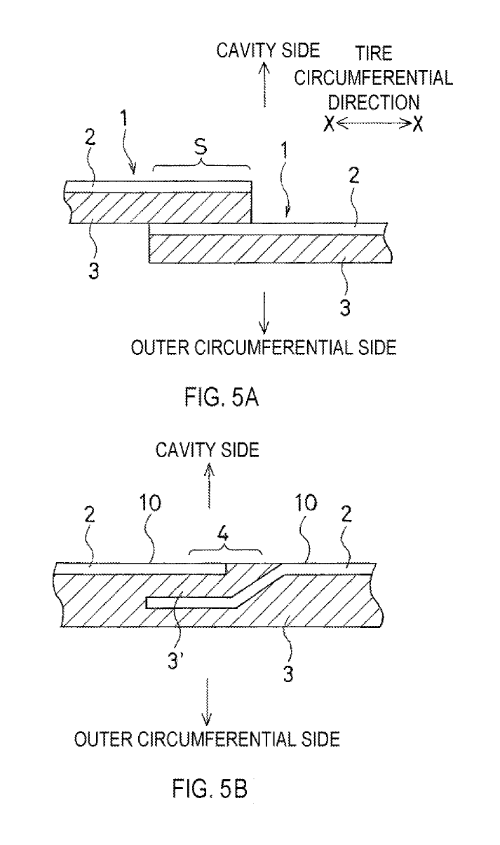

In the conventional pneumatic tire illustrated in FIG. 5, shearing strain within the plane of the sheet 2 obtained from thermoplastic resin or the thermoplastic resin composition of a thermoplastic resin blended with an elastomer causes cracks and/or separation. Such a configuration in the pneumatic tire of the present technology can alleviate shearing strain and suppress the generation of cracks and/or separation due to the fact that a rubber layer 3′ (tie rubber 3) is between the upper and lower sheets 2 that are overlap spliced, and the fact that a plurality of slits 5 extending in a direction having a tire circumferential direction component and having a slit width of not greater than 1.0 mm are provided in a leading edge portion or in the vicinity of a leading edge portion of at least one side of the upper and lower sheets 2 obtained from a thermoplastic resin or a thermoplastic resin composition of a thermoplastic resin blended with an elastomer.

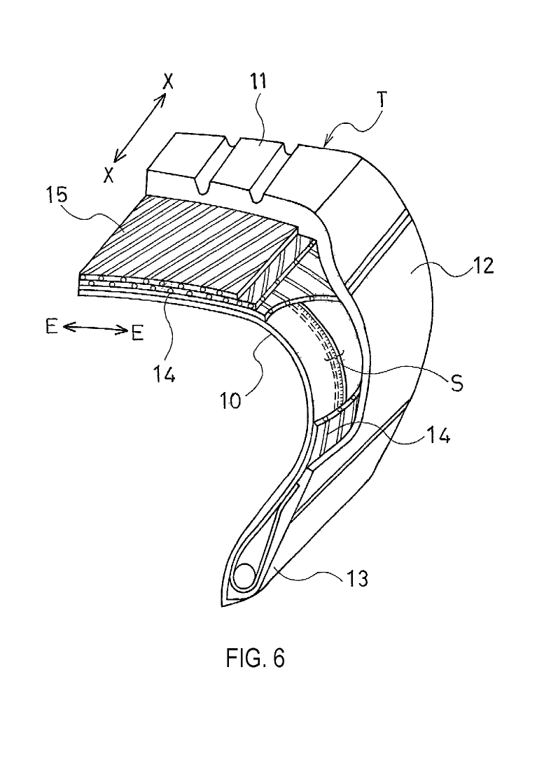

It is crucial that the slits 5 extend in a direction having a tire circumferential direction component and have a slit width of not greater than 1.0 mm, and furthermore, that a plurality of slits are provided. If the slit width is greater than 1.0 mm, it is undesirable because a stress concentration may readily occur, and cutting debris may emerge when cutting the slits. A more preferred slit width is not greater than 0.5 mm. This is because the effect is sufficiently large and cutting is also easier. Furthermore, when the slits 5 do not extend in a direction having a tire circumferential direction component (X-X direction (refer to FIG. 6)), it is undesirable because the shearing strain applied in the tire circumferential direction cannot be alleviated. In FIG. 1, the E-E direction is the tire width direction.

The pneumatic tire of the present technology may have an adhesive rubber layer 6 in the innermost layer on the cavity side, as illustrated in FIG. 1C. By providing the adhesive rubber layer 6, it is possible to more effectively suppress generation of cracks and/or separation in the overlap splice portion S. The adhesive rubber layer 6 may be provided along the overlap splice portion S in the vicinity thereof, or may be provided on the entire inner circumferential surface of the tire cavity.

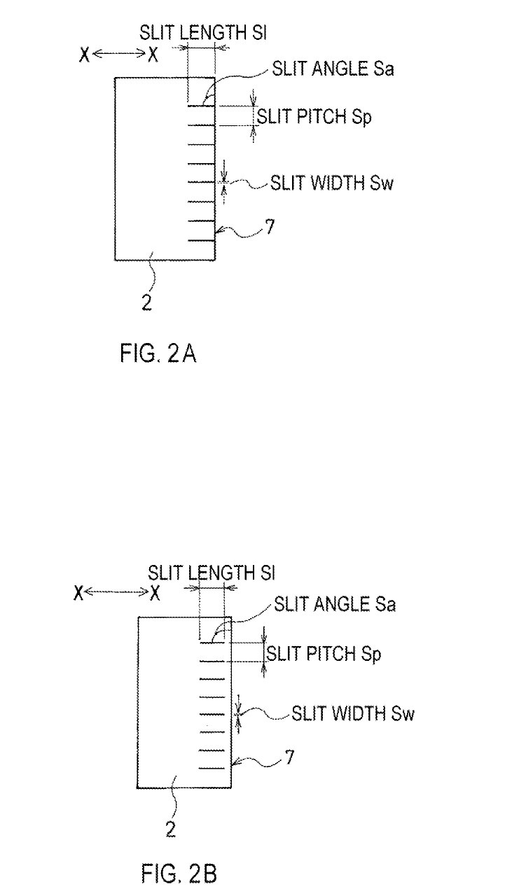

It is preferred that the slits 5 be provided by forming an opening on the leading edge surface of the sheet as illustrated in FIG. 1 and FIG. 2A, but the slits 5 may also be provided in the vicinity of the leading edge of the sheet without forming an opening on the leading edge surface of the sheet, as illustrated in FIG. 2B.

Furthermore, it is preferred that the slits 5 be provided at a slit pitch Sp of not less than 1 mm and not greater than 15 mm. If the slit pitch Sp is smaller than 1 mm, it is undesirable because the slit cutting that provides the slits becomes difficult, and if larger than 15 mm, it is undesirable because the strain alleviation effect and stress alleviation effect become small. Note that the slit pitch Sp is the distance between the center axis lines of adjacent slits. It is crucial that the slit width Sw be not greater than 1.0 mm, as described above. Furthermore, when the slits 5 have a dashed line (dotted line) form, the length is the total of the lengths of the actually formed individual slits.

Also, the slit length Sl, as the length of the tire circumferential direction component, is preferably not less than 0.2 times and not greater than 1.5 times the overlap length L of the splice portion.

If the slit length Sl, as the length of the tire circumferential direction component, is less than 0.2 times the overlap length L of the overlap splice portion, it is undesirable because the strain alleviation effect due to provision of the slits may be reduced, and additionally, productivity will drop because precision is required in slit cutting. Furthermore, if the slit length Sl, as the length of the tire circumferential direction component, is greater than 1.5 times the overlap length L of the overlap splice portion, it is undesirable because the slits become origin points of crack generation.

The slit length Sl, as the length of the tire circumferential direction component, is preferably not less than 0.4 times and not greater than 1.0 times the overlap length L of the overlap splice portion. This is in order to obtain a good shearing strain alleviation effect brought about by the slits, and if not less than 1.0, it is undesirable because the slits themselves become origin points of crack generation. To further increase this effect, the slit length Sl is preferably not less than 0.5 times and not greater than 0.9 times the overlap length L of the splice portion.

Furthermore, it is preferable that the slits 5 be provided having a slit angle Sa of from 30° to 90° relative to a direction of leading edge portion line 7 of the sheet 2, as illustrated in FIGS. 2A and 2B. According to findings by the present inventors, the effect of the present technology is sufficiently exhibited even if the slit angle Sa is 90°, but a greater stress alleviation effect and strain alleviation effect can be obtained when slits 5 having a slit angle Sa within the range of 30° to 90° are provided. The slit angle Sa is particularly preferably in the range of 60° to 90°. It is preferable that slits 5 be provided having such an intersection angle relative to the direction of leading edge portion line 7 of the sheet 2 because crack generation along the slits 5 is markedly suppressed.

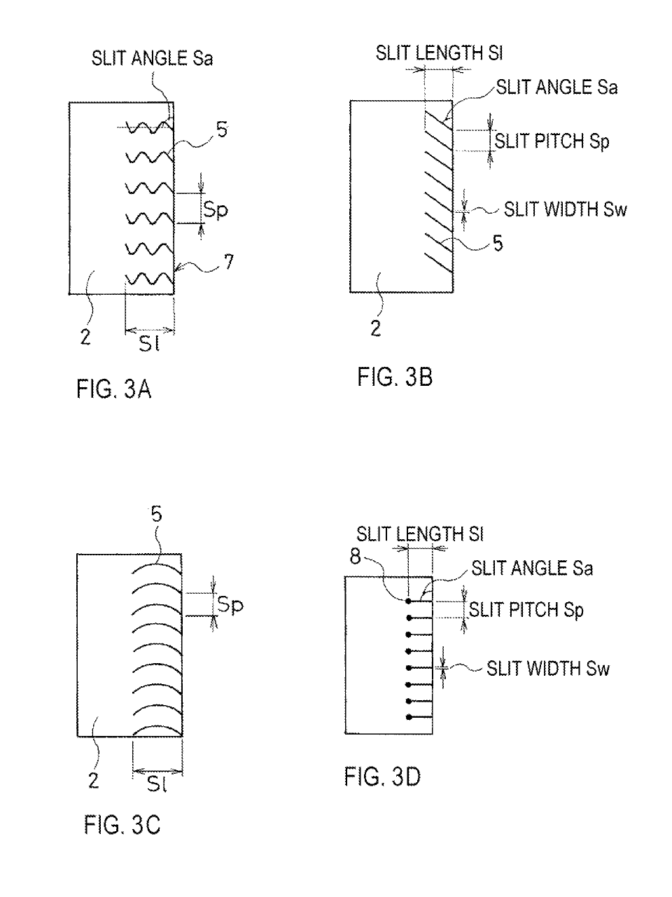

The slits are not limited to those extending linearly, and may have a wave shape as illustrated in FIG. 3A, a shape having a slit angle of less than 90° as illustrated in FIG. 3B, or an arc shape consisting of a single arc as illustrated in FIG. 3C. In the case of these non-linear slits, the intersection angle (slit angle) is, if a wave shape, the angle at which the direction of advancement of the wave and the direction of leading edge line 7 of the laminate sheet intersect, or, if an arc shape consisting of a single arc, the angle at which the line that connects the starting point and end point of the arc and the direction of the leading edge line 7 of the laminate sheet intersect. FIG. 3D illustrates an example in which an expanded portion 8 is provided in the deepest portion of the slits 5. By providing the expanded portion 8, stress concentration and strain concentration in the vicinity of the deepest portion of the slits 5 can be prevented, and the vicinity of the deepest portion can be prevented from becoming the origin point of crack generation.

Of the overlapped sheets 2 obtained from a thermoplastic resin or a thermoplastic resin composition of a thermoplastic resin blended with an elastomer, the slits 5 are preferably provided in the edge portion of the sheet 2 arranged on the tire cavity side. When the slits 5 are positioned on the cavity side, the large effect of the present technology is obtained because cracks and/or separation are readily generated in the cavity side. However, the slits 5 may also be provided in the sheet 2 on the tire outer circumferential side, or in both the top and bottom sheets 2.

Furthermore, the leading edge portion of the sheet 2 obtained from the thermoplastic resin or the thermoplastic resin composition of a thermoplastic resin blended with an elastomer that constitutes the overlap splice portion is preferably sharpened. This is more preferred because sharpening the leading edge portion of the sheet 2 prevents the edge portion of the sheet 2 from readily separating or curling.

As for the level of sharpening, the sharpening is preferably performed such that a thickness T (μm) at a position located inward by a distance of t×⅓ from the leading edge of the sheet obtained from the thermoplastic resin or the thermoplastic resin composition of a thermoplastic resin blended with an elastomer has a relationship that satisfies 0.1 t≦T≦0.8 t.

Here, t is an average thickness (μm) in the tire circumferential direction of a portion not subject to sharpening of the sheet obtained from the thermoplastic resin or the thermoplastic resin composition of a thermoplastic resin blended with an elastomer,

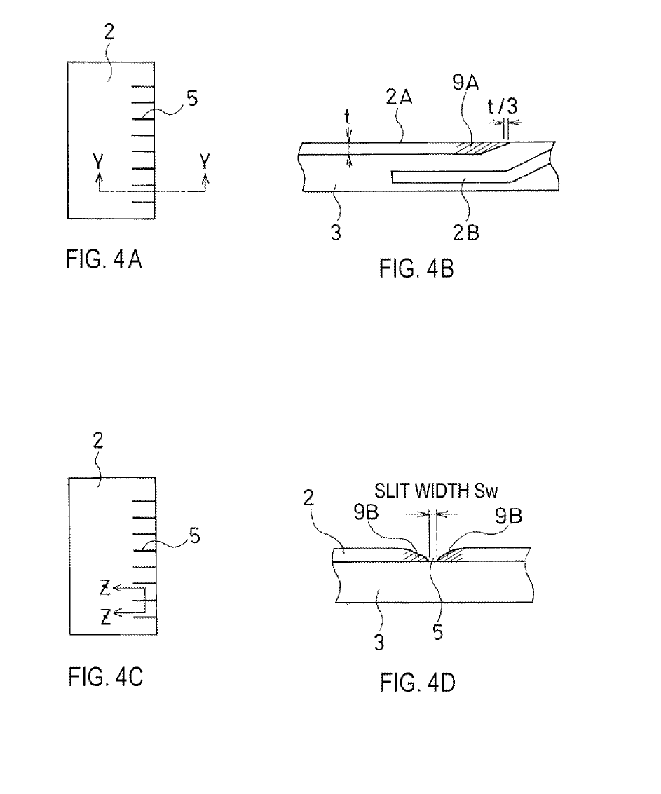

and T is the thickness (μm) of the sheet 2 at a position located inward by a length of t×⅓ from the leading edge of the sheet obtained from the thermoplastic resin or the thermoplastic resin composition of a thermoplastic resin blended with an elastomer. This relationship is illustrated in FIGS. 4A and 4B. FIG. 4A is a plan view, and FIG. 4B is a cross-sectional view in the circumferential direction thereof, which represents a cross-section Y-Y in the vicinity of the overlap splice portion shown in FIG. 4A. The leading edge of the sheet 2 has a sharpened edge portion 9A, indicated by diagonal lines.

Similar to sharpening at the edge portion of such a sheet obtained from the thermoplastic resin or the thermoplastic resin composition of a thermoplastic resin blended with an elastomer, sharpening at both side wall portions of the slits is effective in preventing generation of separation and the like, and is preferred in the present technology. It is preferred that both side wall portions of the slits be sharpened.

As for the level of sharpening at both side wall portions of the slits, the sharpening is preferably performed such that a thickness T (μm) at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer satisfies 0.1 t≦T≦0.8 t

Here, t is the average thickness (μm) in the tire circumferential direction of a portion not subject to sharpening of the sheet obtained from the thermoplastic resin or the thermoplastic resin composition of a thermoplastic resin blended with an elastomer and

and T is the thickness (μm) of the sheet 2 at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer.

This relationship is illustrated in FIGS. 4C and 4D. FIG. 4C is a plan view, and FIG. 4D is a cross-sectional view of the sheet 2 in the radial direction (width direction) thereof, which represents a cross-section Z-Z in the vicinity of the overlap splice portion shown in FIG. 4C. Both side wall portions of the slit 5 have a sharpened edge portion 9B, indicated by diagonal lines.

The technique for forming such sharpened edge portions 9A and 9B is not particularly limited, but a sharpened shape of the leading edge may be formed by, for example, forming cuts or slits while providing pressure so as to squash the sheet 2, using a blade, a laser cutter, a heat cutter, or the like which has been brought to an appropriate temperature (normally not less than the glass transition temperature) as a cutter when cutting the sheet 2 or when forming the slits 5 in the sheet 2.

FIG. 6 is a partially fragmented perspective view illustrating an example of an aspect of the pneumatic tire according to the present technology. A pneumatic tire T is provided with sidewall portions 12 and bead portions 13 so as to communicate on the left and right with a tread portion 11. On the tire inner side, a carcass layer 14 that acts as a framework for the tire is provided so as to extend between the left and right bead portions 13, 13 in the tire width direction. Two belt layers 15 composed of steel cords are provided on the outer circumferential side of the carcass layer 14 corresponding to the tread portion 11. The arrow X indicates the tire circumferential direction. An inner liner layer 10 is disposed on an inner side of the carcass layer 14, and an overlap splice portion S thereof is present extending in the tire width direction. In the pneumatic tire according to the present technology, the generation of cracks that conventionally often occur in the vicinity of the overlap splice portion S on the tire inner circumferential surface, and the generation of cracks between the tie rubber layer 3 and the sheet 2 obtained from the thermoplastic resin or the thermoplastic resin composition that form the inner liner layer 10, and moreover the occurrence of separation, are suppressed and durability is noticeably enhanced.

While the overlap length L of the overlap splice portion S depends on tire size, the length is preferably around 7 to 20 mm, or more preferably around 8 to 15 mm. If the overlap length is too large, uniformity tends to become worse, and if the overlap length is too small, there is a risk that the splice portion may open during molding.

FIG. 6 is a typical example of the case in which the sheet obtained from the thermoplastic resin or the thermoplastic resin composition of a thermoplastic resin blended with an elastomer is used as the sheet that forms an inner liner layer of a pneumatic tire, but in addition to that, it may be used as a reinforcing sheet layer for reinforcing certain portions of a pneumatic tire.

When used as a reinforcing layer, the overlap splice portion S is present across the entire width of the tire, and slits may be provided across the entire width of that splice portion, but that is not necessarily required, and it is preferred that they extend in the tire width direction at least to “the region from the edge portion of the belt layer that has the maximum belt width to the leading edge portion of the bead filler.” In particular, because deformation is large in the vicinity of the shoulder portions and near the sidewall portions during travel, cracking and separation readily occur in the vicinity of the splice portion, so preferably it is provided in the above-described region. It is particularly preferred that they be provided in a region that spans from the above-described region on one side to the above-described region on the opposite side (but excluding the bead part), and, if desired and appropriate, they may be arranged only in the region, or in a center region (tread portion) sandwiched by the above-described regions, or in both of these regions.

When used as this reinforcing layer, it may be used in the case where it is disposed at a portion adjacent to a reinforcing layer such as the carcass layer or belt layer or another rubber layer inside the tire, or, it may be used in the bead portion or a tire surface portion (which is both the external surface and the cavity-side surface), such as the side portion or tread portion.

The thermoplastic resin to be used in the present technology is preferably a polyamide resin [e.g., nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MXD6), nylon 6T, nylon 9T, nylon 6/6T copolymer, nylon 66/PP copolymer, nylon 66/PPS copolymer] or an N-alkoxyalkyl compound thereof, e.g., a methoxymethyl compound of nylon 6, a methoxymethyl compound of a nylon 6/610 copolymer, or a methoxymethyl compound of nylon 612; a polyester resin [e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a crystal polyester, a polyoxyalkylene diimide acid/polybutylene terephthalate copolymer]; a polynitrile resin [e.g., polyacrylonitrile (PAN), polymethacrylonitrile, an acrylonitrile/styrene copolymer (AS), a (meta) acrylonitrile/styrene copolymer, a (meta)acrylonitrile/styrene/butadiene copolymer], a polymethacrylate resin [e.g., polymethyl-methacrylate (PMMA), polyethyl-methacrylic acid], a polyvinyl resin [e.g., polyvinyl acetate, a polyvinyl alcohol (PVA), a vinyl alcohol/ethylene copolymer (EVOH), polyvinylidene chloride (PDVC), polyvinylchloride (PVC), a vinyl chloride/vinylidene chloride copolymer, a vinylidene chloride/methylacrylate copolymer, a vinylidene chloride/acrylonitrile copolymer], a cellulose resin [e.g., cellulose acetate, cellulose acetate butyrate], a fluoride resin [e.g., polyvinylidene difluoride (PVDF), polyvinyl fluoride (PVF), polychlorofluoroethylene (PCTFE), a tetrafluoroethylene/ethylene copolymer (ETFE)], or an imide resin [e.g., an aromatic polyimide (PI)].

Furthermore, in the thermoplastic resin and the elastomer that constitute the thermoplastic resin composition that can be used in the present technology, the above may be used as the thermoplastic resin. The elastomer to be used preferably includes a diene-based rubber and a hydrogenate thereof [e.g., natural rubber (NR), isoprene rubber (IR), epoxidized natural rubber, styrene butadiene rubber (SBR), butadiene rubber (BR, high cis-BR, low cis-BR), nitrile rubber (NBR), hydrogenated NBR, hydrogenated SBR], an olefin rubber [e.g., ethylene propylene rubber (EPDM, EPM), maleic acid ethylene modified propylene rubber (M-EPM), butyl rubber (IIR), an isobutylene and aromatic vinyl or diene-based monomer copolymer, acrylic rubber (ACM), an ionomer], a halogen-containing rubber [e.g., Br-IIR, CI-IIR, a brominated isobutylene-p-methylstyrene copolymer (BIMS), chloroprene rubber (CM), a hydrin rubber (CHR), chlorosulfonated polyethylene rubber (CSM), chlorinated polyethylene rubber (CM), chlorinated polyethylene rubber modified with maleic acid (M-CM)], a silicon rubber [e.g., methyl vinyl silicon rubber, dimethyl silicon rubber, methylphenyl vinyl silicon rubber], a sulfur-containing rubber [e.g., polysulfide rubber], a fluororubber [e.g., a vinylidene fluoride rubber, a vinyl ether rubber containing fluoride, a tetrafluoroethylene-propylene rubber, a silicon-based rubber containing fluoride, a phosphazene rubber containing fluoride], and a thermoplastic elastomer [e.g., a styrene elastomer, an olefin elastomer, an ester elastomer, a urethane elastomer, a polyamide elastomer].

Moreover, when the compatibility is different upon blending by combining the previously specified thermoplastic resin and the previously specified elastomer, a suitable compatibility agent may be used as a third component to enable compatibilization of both the resin and the elastomer. By mixing the compatibility agent in the blend, interfacial tension between the thermoplastic resin and the elastomer is reduced, and as a result, the particle diameter of the elastomer that forms the dispersion phase becomes very small and thus the characteristics of both components may be realized effectively. In general, such a compatibility agent has a copolymer structure of at least one of the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes: a styrene/ethylene butylene block copolymer (SEBS) or a maleic acid modified compound thereof; a EPDM, EPM, EPDM/styrene or EPDM/acrylonitrile graft copolymer or a maleic acid modified compound thereof; a styrene/maleic acid copolymer, or a reactive phenoxy, and the like. The blending quantity of such a compatibility agent, while not being limited, is preferably 0.5 to 10 parts by weight with respect to 100 parts by weight of the polymer component (total of the thermoplastic resin and the elastomer).

A composition ratio of the specific thermoplastic resin and the elastomer in the thermoplastic resin composition of a thermoplastic resin blended with an elastomer, is not limited in particular, may be determined as appropriate to establish a dispersed structure as a discontinuous phase of the elastomer in the matrix of the thermoplastic resin, and is preferably a range of a weight ratio of 90/10 to 30/70.

In the present technology, a compatibility agent or other polymers within a range that does not harm the characteristics required for an inner liner or a reinforcing member may be mixed with the thermoplastic resin or the thermoplastic resin composition of a thermoplastic resin blended with an elastomer.

The purposes of mixing such a polymer are to improve the compatibility between the thermoplastic resin and the elastomer, to improve the molding workability of the material, to improve the heat resistance, to reduce cost, and the like. Examples of the material used for the polymer include polyethylene (PE), polypropylene (PP), polystyrene (PS), ABS, SBS, and polycarbonate (PC). Furthermore, a reinforcing agent such as a filler (calcium carbonate, titanium oxide, alumina, and the like), carbon black, or white carbon, a softening agent, a plasticizer, a processing aid, a pigment, a dye, an anti-aging agent, or the like generally compounded with polymer compounds may be optionally compounded so long as the characteristics required for an inner liner or reinforcing member are not harmed. The thermoplastic resin composition has a structure in which the elastomer is distributed as a discontinuous phase in the matrix of the thermoplastic resin. By having such a structure, it becomes possible to provide the inner liner or the reinforcing member with sufficient flexibility and sufficient stiffness that is attributed to the effect of the resin layer as a continuous phase. Furthermore, it becomes possible to obtain, during molding, a molding workability equivalent to that of the thermoplastic resin regardless of the amount of the elastomer.

Furthermore, the elastomer can be dynamically vulcanized when being mixed in with the thermoplastic resin. A vulcanizer, a vulcanization aid, vulcanization conditions (temperature, time), and the like, during the dynamic vulcanization can be determined as appropriate in accordance with the composition of the elastomer to be added, and are not particularly limited.

When the elastomer in the thermoplastic resin composition is dynamically vulcanized in this manner, the obtained resin sheet becomes a sheet that includes a vulcanized elastomer; therefore, this sheet is preferable in that it has resistance (elasticity) against deformation from the outside, and in particular, it easily maintains the structure of the slit-shaped slit edge lines, and it can reliably obtain the effects of the present technology.

Generally available rubber vulcanizers (crosslinking agents) can be used as the vulcanization agent. Specifically, as a sulfur-based vulcanizer, powdered sulfur, precipitated sulfur, highly dispersible sulfur, surface treated sulfur, insoluble sulfur, dimorpholine disulfide, alkylphenol disulfide, and the like can be illustrated, and, for example, approximately 0.5 to 4 phr (in the present specification, “phr” refers to parts by weight per 100 parts per weight of an elastomer component; same below) can be used.

Moreover, examples of an organic peroxide-based vulcanizer include benzoyl peroxide, t-butyl hydroperoxide, 2,4-dichlorobenzoyl peroxide, 2,5-dimethyl-2,5-di(t-butyl peroxy)hexane, and 2,5-dimethylhexane-2,5-di(peroxyl benzoate). Such an organic peroxide-based vulcanizer can be used in an amount of, for example, around 1 to 20 phr.

Furthermore, examples of a phenol resin-based vulcanizer includes brominated alkylphenol resins and mixed crosslinking system containing an alkyl phenol resin with a halogen donor such as tin chloride and chloroprene. Such a phenol resin-based vulcanizer can be used in an amount of, for example, around 1 to 20 phr.

Examples of other vulcanizers include zinc oxide (approximately 5 phr), magnesium oxide (approximately 4 phr), litharge (approximately 10 to 20 phr), p-quinone dioxime, p-dibenzoylquinone dioxime, tetrachloro-p-benzoquinone, poly-p-dinitrosobenzene (approximately 2 to 10 phr), and methylenedianiline (approximately 0.2 to 10 phr).

As necessary, a vulcanization accelerator may be added. As the vulcanization accelerator, approximately 0.5 to 2 phr, for example, of a generally available vulcanization accelerator of an aldehyde-ammonia base, a guanidine base, a thiazole base, a sulfenamide base, a thiuram base, a dithio acid salt base, a thiourea base, or the like can be used.

Specific examples include an aldehyde ammonia vulcanization accelerator such as hexamethylene tetramine and the like; a guanidine vulcanization accelerator such as diphenyl guanidine and the like; a thiazole vulcanization accelerator such as dibenzothiazyl disulfide (DM), 2-mercaptobenzothiazole and its Zn salt; a cyclohexylamine salt, and the like; a sulfenamide vulcanization accelerator such as cyclohexyl benzothiazyl sulfenamide (CBS), N-oxydiethylene benzothiazyl-2-sulfenamide, N-t-butyl-2-benzothiazole sulfenamide, 2-(thymol polynyl dithio)benzothizole, and the like; a thiuram vulcanization accelerator such as tetramethylthiuram disulfide (TMTD), tetraethylthiuram disulfide, tetramethylthiuram monosulfide (TMTM), dipentamethylenethiuram tetrasulfide, and the like; a dithionate vulcanization accelerator such as Zn-dimethyl dithiocarbamate, Zn-diethyl dithiocarbamate, Zn-n-butyl dithiocarbamate, Zn-ethylphenyl dithiocarbamate, Te-diethyl dithiocarbamate, Cu-dimethyl dithiocarbamate, Fe-dimethyl dithiocarbamate, pipecoline pipecolyl dithiocarbamate, and the like; and a thiourea vulcanization accelerator such as ethylene thiourea, diethyl thiourea, and the like may be mentioned. Additionally, a vulcanization accelerator aid which is generally-used for a rubber can be used. For example, zinc oxide (approximately 5 phr), stearic acid, oleic acid and their Zn salts (approximately 2 to 4 phr), or the like can be used.

The method for producing the thermoplastic resin composition is as follows. The thermoplastic resin and the elastomer (unvulcanized in the case of rubber) are melt-kneaded in advance by a twin-screw kneader extruder or the like. The elastomer is dispersed as a dispersion phase (domain) in the thermoplastic resin forming a continuous phase (matrix). When the elastomer is vulcanized, the vulcanizer can be added during the kneading process to dynamically vulcanize the elastomer. Although the various compounding agents (except for vulcanizer) may be added to the thermoplastic resin or the elastomer during the kneading process, it is preferable to premix the compounding agents before the kneading process. The kneader used for kneading the thermoplastic resin and the elastomer is not particularly limited. A screw extruder, kneader, Banbury Mixer, twin screw kneader extruder, or the like can be used as the kneader. Among these, a twin screw kneader extruder is preferably used for kneading the thermoplastic resin and the elastomer and for dynamically vulcanizing the elastomer. Furthermore, two or more types of kneaders can be used to successively knead the thermoplastic resin and the elastomer. As a condition for the melt-kneading, it is preferable that a temperature be equal to or higher than a melting temperature of the thermoplastic resin. Furthermore, a maximum shearing speed during the kneading process is preferably from 300 to 7,500 sec⁻¹. A total kneading time is from 30 seconds to 10 minutes. Additionally, when a vulcanizing agent is added, a vulcanization time after the addition is preferably from 15 seconds to 5 minutes. The polymer composition produced by the above method may be formed into a desired shape by a generally-used method for forming a thermoplastic resin such as injection molding and extrusion molding.

The thermoplastic resin composition thus obtained has a structure in which the elastomer is dispersed as a discontinuous phase in the matrix of the thermoplastic resin. By having such a structure, sufficient flexibility and the effect of the resin layer as a continuous phase allows both sufficient air permeation prevention for an inner liner or reinforcing layer and strength to be imparted, and also, during molding, independent of the amount of the elastomer, molding workability equal to that of the thermoplastic resin can be obtained.

The Young's moduli of the thermoplastic resin and the thermoplastic resin composition are not particularly limited, but are preferably set to 1 to 500 MPa, and more preferably 25 to 250 MPa.

### EXAMPLES

The pneumatic tire of the present technology will be specifically described below by working examples and the like.

In the working examples and comparative examples below, compulsory testing was conducted in all cases after overlap splicing of the laminate sheet according to the present technology in formation of an inner layer.

Furthermore, the “number of cracks” and “total crack length” of the pneumatic tires were evaluated while comparing the generation of cracks and the generation of separation in the vicinity of the splice portion of the inner liner layer of the cavity of the test tires with the situation in other portions thereof.

As test tires, two 215/70R15 98H tires were produced for each working example and comparative example. They were installed on JATMA (Japan Automobile Tire Manufacturers Association) standard rims 15×6.5 JJ, and with the tire internal pressure set to the JATMA maximum air pressure (240 kPa), they traveled for 50,000 km at a velocity of 80 km/hour.

At that time, the load was 8.82 kN, which is equivalent to 120% of the JATMA maximum load. This test is a compulsory accelerated test in which standards and conditions are harsher than the level of normal use.

As the sheet 2 obtained from the thermoplastic resin or the thermoplastic resin composition that constitutes the inner liner layer, in Comparative Example 1, Comparative Example 2, Working Examples 1 to 6, and Working Examples 7 to 12, sheets 150 μm thick of a thermoplastic resin composition in which N6/66 as the thermoplastic resin and BIMS (brominated poly(isobutylene-co-4-methylstyrene) as the elastomer were blended in a 50/50 ratio were prepared as shown in Table 1.

TABLE 1

| | | Parts by |
|---|---|---|
| | | mass |
| BIMS^{a)} | “Exxpro 3035” made by ExxonMobile | 100 |
| | Chemical Co. | |
| Zinc oxide | “Zinc oxide III” made by Seido Chemical | 0.5 |
| | Industry Co., Ltd. | |
| Stearic acid | Industrial stearic acid | 0.2 |
| Zinc stearate | “Zinc stearate” made by NOF Corporation | 1 |
| N6/66 | “UBENYLON B5033B” made by Ube | 100 |
| | Industries, Ltd. | |
| Modified EEA^{b)} | “HPR-AR201” made by Dupont-Mitsui | 10 |
| | Polychemicals Co., Ltd. | |

Notes:
^{a)}Brominated isobutylene-p-methylstyrene copolymer
^{b)}Maleic anhydride-modified ethylene-ethyl acrylate copolymer

The composition of the adhesive rubber was as shown in Table 2 in all examples.

TABLE 2

| | | Parts by |
|---|---|---|
| | | mass |
| Styrene | “Nipol 1502” made by Zeon Corporation | 50 |
| butadiene rubber | | |
| Natural rubber | SIR-20 | 50 |
| Carbon black | “SEAST V” made by Tokai Carbon Co., | 60 |
| | Ltd. | |
| Stearic acid | Industrial stearic acid | 1 |
| Aromatic oil | “Desolex No. 3” made by Showa Shell | 7 |
| | Sekiyu KK | |
| Zinc oxide | “Zinc oxide III” made by Seido Chemical | 3 |
| | Industry Co., Ltd. | |
| Modified | “Sumikanol 620” made by Taoka Chemical | 2 |
| resorcin | Co., Ltd. | |
| formaldehyde | | |
| condensate | | |
| Methylene donor | Modified ether methylolmelamine | 6 |
| | made by Taoka Chemical Co., Ltd. | |
| | “Sumikanol 507AP” | |
| Sulfur | 5% oil-extension treated sulfur | 6 |
| Vulcanization | Di-2-benzothiazolyl disulfide | 2.2 |
| accelerator | made by Ouchi Shinko Chemical Industrial | |
| | Co., Ltd. “NOCCELLER DM” | |

### Working Examples 1 to 6

### Comparative Example 1

The shapes and dimensions of the slits were as shown in Table 3. In Working Examples 1 to 6 and Comparative Example 1, the overlap length of the overlap splice portion was 10 mm in all cases.

As is understood from these results, according to the present technology, a pneumatic tire with excellent durability in which crack generation is suppressed can be obtained.

TABLE 3

| | | Comparative | Working | Working |
|---|---|---|---|---|
| | | Example 1 | Example 1 | Example 2 |
| Splice structure | | FIG. 1C | FIG. 1C | FIG. 1C |
| Slit shape | | None | FIG. 2A | FIG. 2A |
| Slit location | | — | Cavity side | Cavity side |
| | | | only | only |
| Slit pitch (mm) | | — | 1 mm | 1 mm |
| Slit length (mm) | | — | 10 mm | 10 mm |
| Slit angle (degrees) | | — | 90 degrees | 90 degrees |
| Slit width (mm) | | — | <0.1 mm | <0.1 mm |
| Sharpening of edge portion | | — | No | No |
| Number of cracks (maximum | | 2 | 6 | 10 |
| length) | | (75 mm) | (10 mm) | (12 mm) |
| Crack total length (mm) | | 152 mm | 58 mm | 114 mm |
| | Working | Working | Working | Working |
| | Example 3 | Example 4 | Example 5 | Example 6 |
| Splice structure | FIG. 1C | FIG. 1C | FIG. 1C | FIG. 1C |
| Slit shape | FIG. 2B | FIG. 2A | FIG. 2A | FIG. 2A |
| Slit location | Cavity side | Cavity side | Cavity side | Cavity side |
| | only | only | only | only |
| Slit pitch (mm) | 15 mm | 15 mm | 15 mm | 15 mm |
| Slit length | 8 mm | 2 mm | 4 mm | 15 mm |
| (mm) | (center) | | | |
| Slit angle | 90 degrees | 90 degrees | 90 degrees | 90 degrees |
| (degrees) | | | | |
| Slit width | <0.1 mm | <0.1 mm | <0.1 mm | <0.1 mm |
| (mm) | | | | |
| Sharpening of | No | No | No | No |
| edge portion | | | | |
| Number of | 6 | 8 | 6 | 6 |
| cracks | (12 mm) | (14 mm) | (12 mm) | (10 mm) |
| (maximum | | | | |
| length) | | | | |
| Crack total | 69 mm | 111 mm | 72 mm | 57 mm |
| length (mm) | | | | |

### Working Examples 7 to 12

### Comparative Example 2

The shapes and dimensions of the slits are as shown in Table 4. In Working Examples 1 to 6 and Comparative Example 1, the overlap length L of the overlap splice portion was 10 mm in all cases.

As is understood from these results, according to the present technology, a pneumatic tire with excellent durability in which crack generation is suppressed can be obtained.

TABLE 4

| | Comparative | Working | Working | Working |
|---|---|---|---|---|
| | Example 2 | Example 7 | Example 8 | Example 9 |
| Splice structure | FIG. 1B | FIG. 1B | FIG. 1B | FIG. 1B |
| Slit shape | None | FIG. 2A | FIG. 2A | FIG. 3A |
| Slit location | — | Cavity side | Cavity side | Cavity side |
| | | only | only | only |
| Slit pitch (mm) | — | 15 mm | 15 mm | 15 mm |
| Slit length | — | 10 mm | 10 mm | 10 mm |
| (mm) | | | | |
| Slit angle | — | 90 degrees | 90 degrees | 90 degrees |
| (degrees) | | | | |
| Slit width | — | <0.1 mm | 0.5 mm | <0.1 mm |
| (mm) | | | | |
| sharpening of | — | No | No | No |
| edge portion | | | | |
| Number of | 2 | 6 | 6 | 6 |
| cracks | (80 mm) | (15 mm) | (14 mm) | (15 mm) |
| (maximum | | | | |
| length) | | | | |
| Crack total | 155 mm | 85 mm | 81 mm | 82 mm |
| length (mm) | | | | |

| | Working | Working | Working |
|---|---|---|---|
| | Example 10 | Example 11 | Example 12 |
| Splice structure | FIG. 1B | FIG. 1B | FIG. 1B |
| Slit shape | FIG. 3B | FIG. 2A | FIG. 2A |
| Slit location | Cavity side | Cavity side | Cavity side |
| | only | only | only |
| Slit pitch (mm) | 15 mm | 15 mm | 15 mm |
| Slit length (mm) | 10 mm | 10 mm | 10 mm |
| Slit angle (degrees) | 30 degrees | 90 degrees | 90 degrees |
| Slit width (mm) | <0.1 mm | 0.5 mm | 0.5 mm |
| sharpening of edge portion | No | Leading edge | Slit side wall |
| | | only | |
| Number of cracks | 4 | 0 | 2 |
| (maximum length) | (12 mm) | (—) | (10 mm) |
| Crack total length (mm) | 45 mm | 0 mm | 20 mm |

1. A pneumatic tire comprising an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, the sheet obtained from the thermoplastic resin or the thermoplastic resin composition of a thermoplastic resin blended with an elastomer having a plurality of slits extending in a direction having a tire circumferential direction component and having a slit width of not greater than 1.0 mm, the slits being provided in a leading edge portion or in the vicinity of a leading edge portion of at least one side of the sheet.

2. The pneumatic tire according to claim 1, wherein the slits are provided at a slit pitch of not less than 1 mm and not greater than 15 mm.

3. The pneumatic tire according to claim 1, wherein a length of the slit, as a length of the tire circumferential direction component thereof, is not less than 0.2 times and not greater than 1.5 times an overlap length of the overlap splice portion.

4. The pneumatic tire according to claim 3, wherein a length of the slits, as a length of the tire circumferential direction component thereof, is not less than 0.4 times and not greater than 1.0 times the overlap length of the overlap splice portion.

5. The pneumatic tire according to claim 1, wherein the slits are provided having a slit angle of from 30° to 90° relative to a direction of leading edge portion line of the sheet obtained from the thermoplastic resin or the thermoplastic resin composition of a thermoplastic resin blended with an elastomer.

6. The pneumatic tire according to claim 1, wherein the slits are provided in the sheet that is obtained from the thermoplastic resin or the thermoplastic resin composition of a thermoplastic resin blended with an elastomer and is arranged on a tire cavity side in the overlap splice portion.

7. The pneumatic tire according to claim 1, wherein the leading edge portion of the sheet obtained from the thermoplastic resin or the thermoplastic resin composition of a thermoplastic resin blended with an elastomer in the overlap splice portion is sharpened.

8. The pneumatic tire according to claim 7, wherein, the sharpening is performed such that a thickness T (μm) at a position located inward by a length of t×⅓ from the leading edge of the sheet obtained from the thermoplastic resin or the thermoplastic resin composition of a thermoplastic resin blended with an elastomer satisfies the equation 0.1 t≦T≦0.8 t,
wherein t is an average thickness (μm) in a tire circumferential direction of a portion not subject to sharpening of the sheet obtained from the thermoplastic resin or the thermoplastic resin composition of a thermoplastic resin blended with an elastomer,
and T is a thickness (μm) of the sheet at a position located inward by a length of t×⅓ from the leading edge of the sheet obtained from the thermoplastic resin or the thermoplastic resin composition of a thermoplastic resin blended with an elastomer.

9. The pneumatic tire according to claim 1, wherein both side wall portions of the slits are sharpened.

10. The pneumatic tire according to claim 9, wherein, the sharpening of both side wall portions of the slits is performed such that a thickness T (μm) at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer satisfies the equation 0.1 t≦T≦0.8 t,
wherein t is an average thickness (μm) in a tire circumferential direction of a portion not subject to sharpening of the sheet obtained from the thermoplastic resin or the thermoplastic resin composition of a thermoplastic resin blended with an elastomer,
and T is a thickness (μm) of the sheet at a position located inward by a length of t×⅓ in a perpendicular direction to the slit side walls from the leading edge of the slit side walls of the sheet obtained from the thermoplastic resin or the thermoplastic resin composition of a thermoplastic resin blended with an elastomer.

11. The pneumatic tire according to claim 2, wherein a length of the slit, as a length of the tire circumferential direction component thereof, is not less than 0.2 times and not greater than 1.5 times an overlap length of the overlap splice portion.

12. The pneumatic tire according to claim 11, wherein a length of the slits, as a length of the tire circumferential direction component thereof, is not less than 0.4 times and not greater than 1.0 times the overlap length of the overlap splice portion.

13. The pneumatic tire according to claim 12, wherein the slits are provided having a slit angle of from 30° to 90° relative to a direction of leading edge portion line of the sheet obtained from the thermoplastic resin or the thermoplastic resin composition of a thermoplastic resin blended with an elastomer.

14. The pneumatic tire according to claim 13, wherein the slits are provided in the sheet that is obtained from the thermoplastic resin or the thermoplastic resin composition of a thermoplastic resin blended with an elastomer and is arranged on a tire cavity side in the overlap splice portion.

15. The pneumatic tire according to claim 14, wherein the leading edge portion of the sheet obtained from the thermoplastic resin or the thermoplastic resin composition of a thermoplastic resin blended with an elastomer in the overlap splice portion is sharpened.

16. The pneumatic tire according to claim 15, wherein, the sharpening is performed such that a thickness T (μm) at a position located inward by a length of t×⅓ from the leading edge of the sheet obtained from the thermoplastic resin or the thermoplastic resin composition of a thermoplastic resin blended with an elastomer satisfies the equation 0.1 t≦T≦0.8 t,
wherein t is an average thickness (μm) in a tire circumferential direction of a portion not subject to sharpening of the sheet obtained from the thermoplastic resin or the thermoplastic resin composition of a thermoplastic resin blended with an elastomer,
and T is a thickness (μm) of the sheet 2 at a position located inward by a length of t×⅓ from the leading edge of the sheet obtained from the thermoplastic resin or the thermoplastic resin composition of a thermoplastic resin blended with an elastomer.

17. The pneumatic tire according to claim 16, wherein both side wall portions of the slits are sharpened.

18. The pneumatic tire according to claim 17, wherein, the sharpening of both side wall portions of the slits is performed such that a thickness T (μm) at a position located inward by a length of t×⅓ in a direction perpendicular to the slit side walls from the leading edge of the slit side walls of the sheet obtained from the thermoplastic resin or the thermoplastic resin composition of a thermoplastic resin blended with an elastomer satisfies the equation 0.1 t≦T≦0.8 t,
wherein t is an average thickness (μm) in a tire circumferential direction of a portion not subject to sharpening of the sheet obtained from the thermoplastic resin or the thermoplastic resin composition of a thermoplastic resin blended with an elastomer,
and T is a thickness (μm) of the sheet 2 at a position located inward by a length of t×⅓ in a perpendicular direction to the slit side walls from the leading edge of the slit side walls of the sheet obtained from the thermoplastic resin or the thermoplastic resin composition of a thermoplastic resin blended with an elastomer.
